(19) United States
(12) Patent Application Publication
(10) Pub. No.: US 2026/0241834 A1
(43) Pub. Date: Aug. 20, 2026

(54) BATTERY CONTROL APPARATUS

(71) Applicant: SUBARU CORPORATION, Tokyo (JP)

(72) Inventor: Yuya MUKAINAKANO, Tokyo (JP)

(21) Appl. No.: 19/456,076

(22) Filed: Jan. 22, 2026

(30) Foreign Application Priority Data
Feb. 20, 2025 (JP) 2025-025659

(51) Int. Cl. B60L 58/19; B60L 15/00; B60L 58/13; B60L 58/22

(52) U.S. Cl. CPC B60L 58/19; B60L 15/007; B60L 58/13; B60L 58/22; B60L 2210/10; B60L 2210/46; B60L 2240/527

(57) ABSTRACT

A battery control apparatus is configured to be applied to a battery system including three or more batteries for power supply to a drive motor of a vehicle, and a switcher for switching connections between the batteries. The battery control apparatus includes one or more processors and one or more memories coupled to the processors. The processors are configured to identify, among the batteries, first batteries having states of charge (SOCs) greater than or equal to a first threshold and second batteries having SOCs less than the first threshold, control the switcher to configure a series-parallel connection state by coupling the second batteries in parallel and coupling the first batteries in series with the second batteries to supply power to the drive motor, and control the switcher to release the series-parallel connection state when SOC differences among the three or more batteries are less than a second threshold.

### CROSS-REFERENCE TO RELATED APPLICATIONS

The present application claims priority from Japanese Patent Application No. 2025-025659 filed on Feb. 20, 2025, the entire contents of which are hereby incorporated by reference.

### BACKGROUND

The disclosure relates to a battery control apparatus.

Technologies for balancing the remaining capacity differences among multiple replaceable batteries have been known.

For example, Japanese Unexamined Patent Application Publication (JP-A) No. 2022-149726 discloses a control apparatus characterized by including a power supply unit incorporating replaceable batteries, an output unit configured to operate on electrical power from the power supply unit, an acquisition unit configured to acquire remaining capacity information about the remaining capacity of each battery, and a control unit configured to control charging and discharging of the batteries so that the remaining capacity differences among the batteries are maintained within an allowable range based on the remaining capacity information acquired by the acquisition unit.

### SUMMARY

An aspect of the disclosure provides a battery control apparatus configured to be applied to a battery system including three or more batteries configured to supply power to a drive motor of a vehicle, and a switcher configured to switch connections between the three or more batteries. The battery control apparatus includes one or more processors and one or more memories communicatively coupled to the one or more processors. The one or more processors are configured to identify one or more first batteries having respective states of charge greater than or equal to a first threshold among the three or more batteries. The one or more processors are configured to identify two or more second batteries having respective states of charge less than the first threshold among the three or more batteries. The one or more processors are configured to control the switcher to configure a series-parallel connection state by coupling the identified two or more second batteries in a parallel connection and coupling the one or more first batteries in a series connection with the identified two or more second batteries to supply power to the drive motor. The one or more processors are configured to control the switcher to release the series-parallel connection state when state-of-charge differences among the three or more batteries are less than a second threshold.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic diagram illustrating the outline of a configuration of a vehicle equipped with a battery control apparatus according to an embodiment of the disclosure;

FIG. 2 is a circuit diagram illustrating an example of a configuration of a battery and a switcher in a battery system according to the embodiment of the disclosure;

FIG. 3 is a block diagram illustrating an example of a configuration of the battery control apparatus according to the embodiment of the disclosure;

FIG. 4 illustrates a series-parallel connection state configured for state of charge (SOC) adjustment according to the embodiment of the disclosure;

FIG. 5 illustrates an example of temporal changes in current during SOC adjustment according to the embodiment of the disclosure;

FIG. 6 illustrates an example of temporal changes in SOCs during SOC adjustment according to the embodiment of the disclosure;

FIG. 7 is a flowchart illustrating an example of operation of the battery control apparatus according to the embodiment of the disclosure;

FIG. 8 is a circuit diagram illustrating an example of a configuration of a battery and a switcher in a battery system according to an embodiment of the disclosure; and

FIG. 9 is a flowchart illustrating an example of operation of the battery control apparatus according to the embodiment of the disclosure.

### DETAILED DESCRIPTION

When batteries are replaced in electric vehicles, especially electric vehicles using multiple replaceable batteries coupled in series, all the batteries are replaced together with batteries having a high state of charge (SOC). This is because if some of the batteries are replaced with batteries having a high SOC, the usable capacity is limited by the battery having the lowest SOC while the vehicle is in operation, and as a result, the batteries having a high SOC can no longer be used.

As a method for adjusting the SOCs of multiple batteries, one conceivable method is to switch the connection of the batteries from series to parallel, so that current flows from the batteries with a high SOC to the batteries with a low SOC. With regard to this method, for example, as disclosed in the technology in JP-A No. 2022-149726, current is passed from batteries with a high SOC to batteries with a low SOC so that the remaining capacity differences among batteries are maintained within an allowable range. However, this method has a problem that it takes time to balance the SOCs of all the batteries. Another problem is that the battery capacities are consumed by a circulating current that flows among the batteries.

It is desirable to provide a technology for shortening the time to balance the SOCs of all the batteries as well as for suppressing the circulating current that flows among the batteries.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. First Embodiment

### 1-1. Vehicle

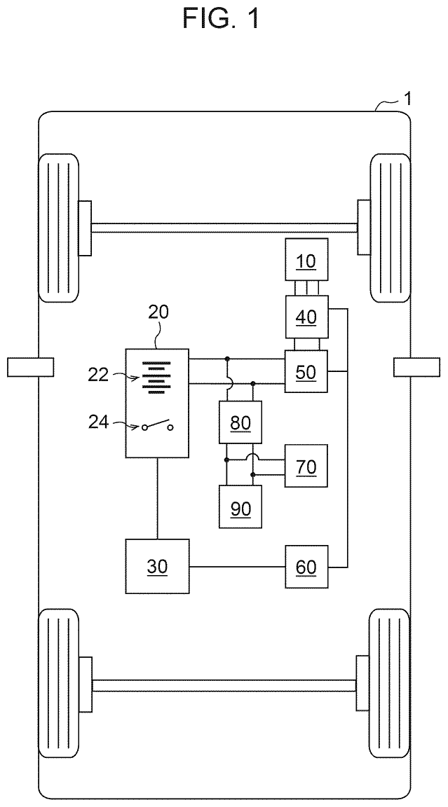

Referring to FIG. 1, a vehicle 1 is an electric vehicle in which drive torque is output from a drive motor 10 for generating drive torque for the vehicle 1, and the drive torque is transmitted to the wheels. Examples of electric vehicles include a Battery Electric Vehicle (BEV), a Hybrid Electric Vehicle (HEV), a Plug-in Hybrid Electric Vehicle (PHEV), and a Fuel Cell Electric Vehicle (FCEV).

The combination of drive wheels and the drive method are not limited to any particular type. For example, the vehicle 1 may be a front-wheel drive vehicle, a rear-wheel drive vehicle, or a four-wheel drive vehicle. The vehicle 1 may be an electric vehicle equipped with, for example, two drive motors including a front-wheel drive motor and a rear-wheel drive motor. The vehicle 1 may be an electric vehicle equipped with drive motors corresponding to respective wheels.

The drive motor 10 is configured as, for example, a three-phase alternating current motor. In this case, a rotating magnetic field is formed as a result of supplying three-phase AC power to the stator (not illustrated) included in the drive motor 10, and the rotor (not illustrated) included in the drive motor 10 rotates to output drive torque. The drive motor 10 is operable to generate regenerative power by rotation of the rotor caused by the rotational torque of the wheels, while the three-phase alternating current is not being supplied to the stator. However, the drive motor 10 is not limited to a three-phase alternating current motor. Any known or other suitable motor may be used, provided that the motor is capable of generating drive torque.

The vehicle 1 includes a battery system 20 that supplies electrical power to the drive motor 10, and a battery control apparatus 30 that controls the battery system 20.

The battery system 20 includes at least components such as three or more batteries 22 that supply power to the drive motor 10 and a switcher 24 that switches connections between the three or more batteries 22. The batteries 22 illustrated in FIG. 1 are coupled in series during normal use. However, the disclosure is not limited to this example, and the batteries 22 may be coupled in parallel during normal use.

The batteries 22 are secondary batteries capable of supplying and receiving power to and from the drive motor 10. The batteries 22 are, for example, lithium-ion batteries or all-solid-state batteries each having a rated voltage of 200 V. The rated voltage and type of the batteries 22 are not particularly limited, provided that the batteries 22 are capable of supplying and receiving power to and from the drive motor 10. For the sake of simplicity, the following description refers to a case in which the vehicle 1 includes three batteries 22a, 22b, and 22c (hereinafter collectively referred to as the “batteries 22” when no distinction is made). However, the number of the batteries 22 in the disclosure is not particularly limited, provided that the number of batteries 22 is three or more.

The batteries 22 are replaceable batteries 22. As used herein, “replaceable” means that the batteries 22 are detachably mounted to the vehicle 1. For example, “replaceable” may mean that the batteries 22 can be removed from a battery case (not illustrated) provided in the vehicle 1, for replacement or charging, by releasing a locking mechanism (not illustrated) of the batteries 22. “Replaceable” may also mean that the batteries 22 can be reattached to the battery case provided in the vehicle 1 after replacement or charging is completed, and that the locking mechanism of the batteries 22 can be locked. The disclosure is not particularly limited with respect to the structure for detachably mounting the batteries 22 to the vehicle 1, and any known or other suitable structure may be used. The batteries 22 in the disclosure are not necessarily replaceable batteries, but may be non-replaceable batteries.

The switcher 24 includes multiple switches that are electrically coupled to the battery control apparatus 30. The switches switch connections between the batteries 22 in response to commands from the battery control apparatus 30. The switches may include any known or other suitable switching elements, such as relays or semiconductor elements. The number of the switches may be set to any number based on the number of the batteries 22 and is not particularly limited.

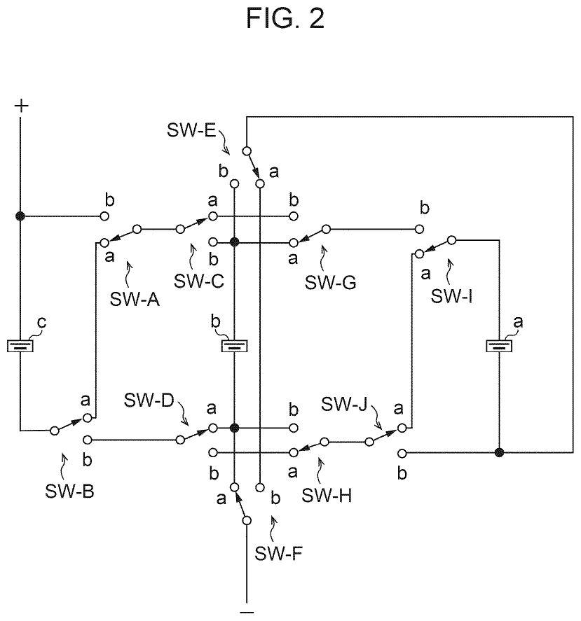

Referring to FIG. 2, an example of the configuration of the batteries 22 and the switcher 24 will be described in detail. The circuit illustrated in FIG. 2 includes, as the batteries 22, batteries a, b, and c, and as the switcher 24, switches SW-A, SW-B, SW-C, SW-D, SW-E, SW-F, SW-G, SW-H, SW-I, and SW-J. In FIG. 2, “+” indicates coupling to a busbar on the positive electrode side of an inverter 40 via a converter 50, and “−” indicates coupling to a busbar on the negative electrode side of the inverter 40 via the converter 50. For example, when the batteries a, b, and c are used as the batteries 22, the switches SW-A to SW-J are configured in any suitable manner to satisfy the following four conditions:
the batteries a to c are coupleable in series or parallel;
the batteries b and c are coupled in parallel, and the battery a is coupleable in series with the batteries b and c;
the batteries a and b are coupleable in parallel, and the battery c is coupleable in series with the batteries a and b;
the batteries a and c are coupleable in parallel, and the battery b is coupleable in series with the batteries a and c.

In FIG. 2, the switches SW-A to SW-J are illustrated as single-pole double-throw switching elements. However, the disclosure is not limited to this example.

Returning to FIG. 1, the vehicle 1 further includes the inverter 40, which is electrically coupled to the drive motor 10, and the converter 50, which is electrically coupled to the inverter 40, as well as the battery system 20 described above.

The inverter 40 includes any known or other suitable inverter circuit (not illustrated) that converts direct-current power drawn from the batteries 22 into, for example, three-phase alternating-current power and supplies the power to the stator of the drive motor 10. This inverter circuit converts three-phase alternating-current power generated by regenerative operation of the stator of the drive motor 10 into direct-current power and supplies the power to the converter 50. The operation of the inverter 40 is controlled by a vehicle control apparatus 60 including one or more electronic control units (ECUs).

The converter 50 adjusts the voltage output by the batteries 22 and also adjusts the voltage output by the inverter 40. The converter 50 includes any known or other suitable buck-boost circuit (not illustrated) that increases or decreases the voltage of power. The operation of the converter 50 is controlled by the vehicle control apparatus 60. The converter 50 may receive commands from the battery control apparatus 30 as will be described later.

In addition, the vehicle 1 includes any known or other suitable steering unit (not illustrated) and any known or other suitable brake unit (not illustrated), which are used for operation control. The operations of the steering unit and the brake unit are controlled by the vehicle control apparatus 60.

The vehicle 1 may include a surrounding environment sensor (not illustrated) that detects the surrounding environment of the vehicle 1, such as a vehicle-mounted camera or a rangefinder sensor, a vehicle state sensor (not illustrated) that detects the state of the vehicle 1, and a location detection sensor (not illustrated) that detects the location of the vehicle 1.

### 1-2. Battery Control Apparatus

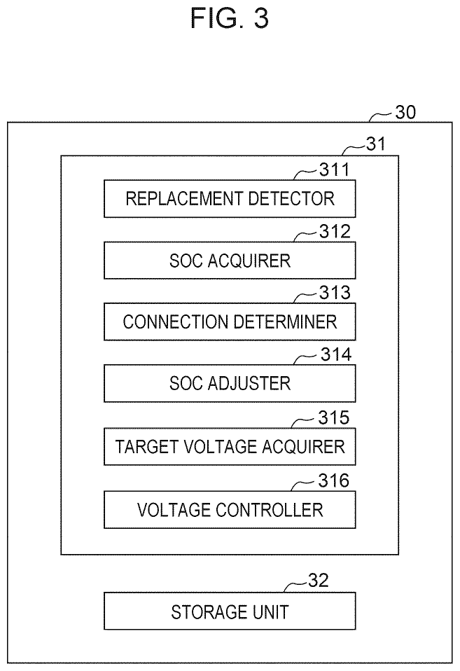

Referring to FIG. 3, the battery control apparatus 30 according to the present embodiment will be described in detail.

### 1-2-1. Configuration Example

The battery control apparatus 30 serves as an apparatus used for the battery system 20 with one or more processors, such as central processing units (CPUs), executing computer programs. The computer programs are configured to cause the processors to perform operations to be implemented by the battery control apparatus 30. The operations will be described later. The computer programs executed by the processors may be stored on a recording medium serving as a storage unit (memory) 32, which will be described later, or on a recording medium built in the battery control apparatus 30 or any recording medium externally coupleable to the battery control apparatus 30.

The recording medium that records the computer programs may be a magnetic medium such as a hard disk, a floppy disk, or a magnetic tape, an optical recording medium such as a compact disc read-only memory (CD-ROM), a digital versatile disc (DVD), or a Blu-ray (registered trademark) disc, a magneto-optical medium such as a Floptical disk, a storage element such as a random-access memory (RAM) and a read-only memory (ROM), a flash memory such as a Universal Serial Bus (USB) flash drive or a solid state drive (SSD), or any other medium capable of storing programs.

The battery control apparatus 30 includes at least components such as a processing unit 31 and a storage unit 32. The battery control apparatus 30 may be electrically coupled to the vehicle control apparatus 60, or one, some, or all configuration elements may be incorporated in the vehicle control apparatus 60.

The processing unit 31 includes one or more processors such as CPUs and various peripheral components. A part or all of the processing unit 31 may be implemented by, for example, updatable software such as firmware or program modules executable according to commands provided by CPUs or other elements.

The storage unit 32 is composed of one or more storage elements, such as RAM and ROM, that are communicatively coupled to the processing unit 31. The type and number of the elements constituting the storage unit 32 are not particularly limited. The storage unit 32 stores computer programs to be executed by the processing unit 31, various parameters to be used in computational processing, and information such as detection data and computation results. For example, the storage unit 32 prestores data including information of first to third thresholds, which are used to determine the connection of the batteries 22.

### 1-2-2. Functional Configuration of Processing Unit

The functional configuration of the processing unit 31 of the battery control apparatus 30 will be described. The processing unit 31 includes a replacement detector 311, an SOC acquirer 312, a connection determiner 313, an SOC adjuster 314, a target voltage acquirer 315, and a voltage controller 316. The respective elements are implemented by the one or more processors, such as CPUs, executing computer programs. Alternatively, one, some, or all of the elements may be implemented using analog circuits. The target voltage acquirer 315 and the voltage controller 316 are non-essential configuration elements for achieving the effects of the disclosure and are optional.

### Replacement Detector

The replacement detector 311 detects that a replacement of the batteries 22 has occurred. For example, the replacement detector 311 detects that the locking mechanism has been released, the batteries 22 have been removed from the battery case, new batteries 22 have been mounted in the battery case, and the locking mechanism has been locked.

### SOC Acquirer

The SOC acquirer 312 acquires the SOCs of the batteries 22 and outputs the SOCs to the connection determiner 313. The SOC can be calculated using any known or other suitable method. For example, the SOC may be calculated based on parameters such as the accumulated value of the charge and discharge current detected by a current sensor (not illustrated) included in the battery system 20. However, the disclosure is not limited to this example.

### Connection Determiner

The connection determiner 313 identifies one or more first batteries 22-1 having SOCs greater than or equal to the first threshold among the batteries 22 and outputs the identification result to the SOC adjuster 314. For example, the connection determiner 313 compares the SOCs acquired by the SOC acquirer 312 with the first threshold prestored in the storage unit 32 to identify one or more first batteries 22-1 having SOCs greater than or equal to the first threshold.

The connection determiner 313 identifies two or more second batteries 22-2 having SOCs smaller than the first threshold among the batteries 22 and outputs the identification result to the SOC adjuster 314. For example, the connection determiner 313 compares the SOCs acquired by the SOC acquirer 312 with the first threshold prestored in the storage unit 32 to identify two or more second batteries 22-2 having SOCs smaller than the first threshold.

### SOC Adjuster

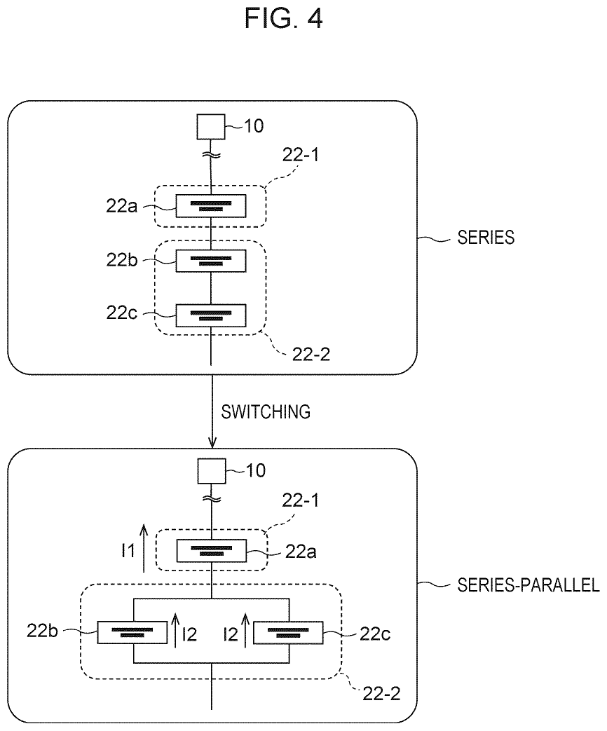

The SOC adjuster 314 controls the switcher 24 to configure the series-parallel connection state of the three or more batteries 22 to supply power to the drive motor 10. The term “series-parallel connection state” as used herein refers to a state in which two or more second batteries 22-2 identified by the connection determiner 313 are coupled in parallel, and one or more first batteries 22-1 are coupled in series with the two or more second batteries 22-2 identified by the connection determiner 313. The technical significance of this control operation performed by the SOC adjuster 314 will be described below with reference to FIGS. 4 to 6.

Here, as an example, it is assumed that the battery 22a among the batteries 22a, 22b, and 22c has been replaced, and the battery 22a having an SOC of 100%, the battery 22b having an SOC of 90%, and the battery 22c having an SOC of 80% have been coupled in series. It is also assumed that the connection determiner 313 has identified the battery 22a as the first battery 22-1, and the batteries 22b and 22c as the second batteries 22-2.

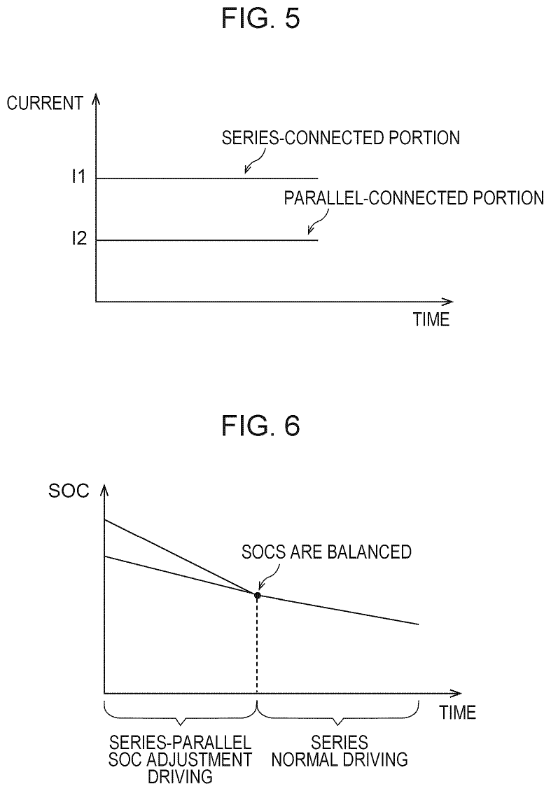

In this case, as illustrated in FIG. 4, the SOC adjuster 314 controls the switcher 24 to configure a series-parallel connection state in which the batteries 22b and 22c are coupled in parallel, and the battery 22a is coupled in series with the batteries 22b and 22c to supply power to the drive motor 10. As illustrated in FIGS. 4 and 5, the current I1 flowing through the battery 22a that constitutes the series-connected portion is twice the current I2 flowing through each of the batteries 22b and 22c that constitutes the parallel-connected portion. As a result, as illustrated in FIG. 6, the SOC of the battery 22a decreases at twice the rate of the SOCs of the batteries 22b and 22c. While power continues to be supplied to the drive motor 10 in the series-parallel connection state illustrated in FIG. 4, the SOCs of the batteries 22a, 22b, and 22c become balanced at a certain point as illustrated in FIG. 6. The adjustment of the SOCs of the batteries 22a, 22b, and 22c is performed by the SOC adjuster 314 in such manner.

The factor “twice” is determined based on the number of second batteries 22-2 that are coupled in parallel. When the number of second batteries 22-2 is N (N is a natural number), the factor becomes N times. The term “balance” as used in the disclosure does not necessarily mean mathematical equality in a strict sense. For example, the term “balance” may refer to such a degree of equality that the drive motor 10 or other elements do not malfunction when power is supplied to the drive motor 10 while three or more batteries 22, the SOCs of which can be regarded as being balanced, are coupled in series or in parallel.

Overall, by configuring a series-parallel connection state of three or more batteries 22 to supply power to the drive motor 10, the SOCs decrease at different rates between the first batteries 22-1, which are coupled in series, and the second batteries 22-2, which are coupled in parallel. As a result, after a certain amount of time elapses since the series-parallel connection state has been configured, the SOCs become balanced at a certain point. This configuration enables balancing of the SOCs of all the batteries 22 through relatively fast power consumption by the drive system caused by driving of the vehicle 1 (hereinafter also referred to as “SOC adjustment driving”), without stopping the vehicle 1 for SOC adjustment after the replacement of the batteries 22. To balance the SOCs of all the batteries 22, this configuration also avoids supplying current from the batteries 22 having higher SOC to the batteries 22 having lower SOCs for a long period of time (for example, approximately one hour) after the batteries 22 have been switched from a series connection to a parallel connection, as in known methods. This configuration thus shortens the time to balance the SOCs of all the batteries 22, as compared with known technologies, and also suppresses the circulating current flowing among the batteries 22.

The connection determiner 313 and the SOC adjuster 314 may perform the following operation to configure a series-parallel connection state as described above. The connection determiner 313 selects a particular battery 22 among the two or more second batteries 22-2 to be coupled to the identified one or more first batteries 22-1, based on the SOCs of the identified two or more second batteries 22-2, and outputs the selection result to the SOC adjuster 314. In response to receiving the selection result from the connection determiner 313, the SOC adjuster 314 controls the switcher 24 to couple the identified one or more first batteries 22-1 and the selected batteries 22 in series to supply power to the drive motor 10. The SOC adjuster 314 controls the switcher 24 such that, when the SOC differences among the two or more second batteries 22-2 become less than the third threshold, the series connection is released and the series-parallel connection state is configured to supply power to the drive motor 10. In this manner, when the SOCs of the three or more batteries 22 are not equal to one another, this configuration balances the SOCs of all the batteries 22 by configuring the series-parallel connection state described above without stopping the vehicle 1.

Here, as an example, it is assumed that the SOC of the battery 22a is 100%, the SOC of the battery 22b is 80%, the SOC of the battery 22c is 70%, and the connection determiner 313 identifies the battery 22a as the first battery 22-1, and the batteries 22b and 22c as the second batteries 22-2. In this case, the SOC adjuster 314 controls the switcher 24 to couple, for example, the battery 22b, which has the higher SOC of the batteries 22b and 22c, in series with the battery 22a to supply power to the drive motor 10. In this manner, the SOC adjuster 314 causes the batteries 22a and 22b to supply power to the drive motor 10, for example, so that the SOC of the battery 22a decreases to 90% and the SOC of the battery 22b decreases to 70%. As a result, among the batteries 22a, 22b and 22c, the batteries 22b and 22c are first adjusted to have the same SOC of 70%. At this time, power is not supplied from the battery 22c. Subsequently, the SOC adjuster 314 controls the switcher 24 such that the batteries 22b and 22c, both of which have an SOC of 70%, are coupled in parallel, and the battery 22a, which has an SOC of 90%, is coupled in series with the batteries 22b and 22c.

The SOC adjuster 314 releases the series-parallel connection state when the SOC differences among the three or more batteries 22 become less than the second threshold. For example, the SOC adjuster 314 performs a comparison based on the SOCs acquired by the SOC acquirer 312 with the second threshold prestored in the storage unit 32 to determine whether the SOC differences are less than the second threshold. The SOC adjuster 314 controls the switcher 24 such that, after the release of the series-parallel connection state, the three or more batteries 22 are coupled in series or in parallel to supply power to the drive motor 10. As a result, the vehicle 1 returns to normal driving from SOC adjustment driving.

### Target Voltage Acquirer

The target voltage acquirer 315 acquires a target voltage for the drive motor 10 during the series-parallel connection state described above. For example, the target voltage acquirer 315 may calculate the target torque of the drive motor 10 based on the amount of depression of the accelerator pedal (not illustrated) and acquire an inverter voltage that realizes the calculated target torque as the target voltage. The relationship between the target torque and the target voltage may be prestored in the storage unit 32 so that the target voltage acquirer 315 can refer to the target torque and the target voltage.

### Voltage Controller

The voltage controller 316 controls the converter 50, which corresponds to a voltage converter, to increase or decrease the voltage of the power supplied to the drive motor 10 to reach the target voltage acquired by the target voltage acquirer 315. For example, in a case in which the batteries 22 are coupled in series during normal use, when the batteries 22 are brought into a series-parallel connection state for SOC adjustment, the system voltage becomes lower than the system voltage during normal use. To address this condition, the voltage controller 316 controls the converter 50, which is an example of a voltage converter, through the vehicle control apparatus 60 to increase the voltage of the power supplied to the drive motor 10 to reach the target voltage acquired by the target voltage acquirer 315. By contrast, in a case in which the batteries 22 are coupled in parallel during normal use, when the batteries 22 are brought into a series-parallel connection state for SOC adjustment, the system voltage becomes higher than the system voltage during normal use. To address this condition, the voltage controller 316 controls the converter 50, which is an example of a voltage converter, through the vehicle control apparatus 60 to decrease the voltage of the power supplied to the drive motor 10 to reach the target voltage acquired by the target voltage acquirer 315.

### 1-2-3. Example of Operation of Battery Control Apparatus

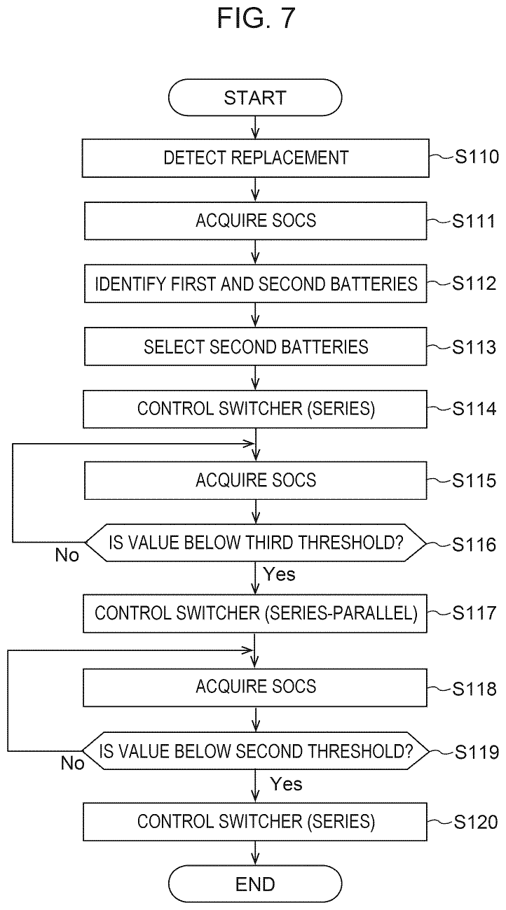

Referring to FIG. 7, an example of operation of the battery control apparatus 30 according to the first embodiment will be described following a flowchart.

For the sake of simplicity, the following description refers to a case in which the battery 22a among the replaceable batteries 22a, 22b, and 22c has been replaced. It is assumed that the SOC of the battery 22a is 100%, the SOC of the battery 22b is 80%, and the SOC of the battery 22c is 70%. It is also assumed that the batteries 22a, 22b, and 22c are used in a series connection during normal driving of the vehicle 1. However, the disclosure is not limited to these conditions.

In step S110, the replacement detector 311 of the processing unit 31 detects that the replacement of the batteries 22a, 22b, and 22c has been performed. Subsequently, the process proceeds to step S111.

In step S111, the SOC acquirer 312 of the processing unit 31 acquires the SOCs of the batteries 22a, 22b, and 22c. The SOC acquirer 312 may monitor the SOCs continuously at predetermined computation intervals during the process. The same applies to the following descriptions. Subsequently, the process proceeds to step S112.

In step S112, the connection determiner 313 of the processing unit 31 identifies, as the first battery 22-1, the battery 22a that has a SOC greater than or equal to the first threshold among the batteries 22a, 22b, and 22c. The connection determiner 313 also identifies, as the second batteries 22-2, the batteries 22b and 22c that have SOCs less than the first threshold among the batteries 22a, 22b and 22c. Subsequently, the process proceeds to step S113.

In step S113, the connection determiner 313 of the processing unit 31 selects, based on the SOCs of the batteries 22b and 22c identified in step S112, a second battery 22-2 to be coupled to the battery 22a from the batteries 22b and 22c. In this example of operation, it is assumed that the battery 22b is selected through the method described above. Subsequently, the process proceeds to step S114.

In step S114, the SOC adjuster 314 of the processing unit 31 controls the switcher 24 to couple the battery 22b selected in step S113 in series with the battery 22a to supply power to the drive motor 10. For example, referring to FIG. 2, the SOC adjuster 314 controls the switch SW-A, which corresponds to the switcher 24, to establish a connection to a contact ‘b’. The SOC adjuster 314 also controls the switch SW-B, which corresponds to the switcher 24, to establish a connection to a contact ‘a’. The SOC adjuster 314 also controls the switch SW-C, which corresponds to the switcher 24, to establish a connection to a contact ‘b’. The SOC adjuster 314 also controls the switch SW-D, which corresponds to the switcher 24, to establish a connection to a contact ‘b’. The SOC adjuster 314 also controls the switch SW-E, which corresponds to the switcher 24, to establish a connection to a contact ‘a’. The SOC adjuster 314 also controls the switch SW-F, which corresponds to the switcher 24, to establish a connection to a contact ‘b’. The SOC adjuster 314 also controls the switch SW-G, which corresponds to the switcher 24, to establish a connection to a contact ‘b’. The SOC adjuster 314 also controls the switch SW-H, which corresponds to the switcher 24, to establish a connection to a contact ‘b’. The SOC adjuster 314 also controls the switch SW-I, which corresponds to the switcher 24, to establish a connection to a contact ‘a’. The SOC adjuster 314 also controls the switch SW-J, which corresponds to the switcher 24, to establish a connection to a contact ‘a’. In step S114, for example, the SOC of the battery 22a is targeted to be 90%, and the SOC of the battery 22b is targeted to be 70%. Subsequently, the process proceeds to step S115.

In step S114, the target voltage acquirer 315 of the processing unit 31 may acquire the target voltage of the drive motor 10 using the method described above. The voltage controller 316 may control the converter 50, which is an example of a voltage converter, to increase the voltage of the power supplied to the drive motor 10 to reach the target voltage acquired by the target voltage acquirer 315. This control can suppress a decrease in the system voltage that occurs because the series connection is formed by the batteries 22a and 22b.

In step S115, the SOC acquirer 312 of the processing unit 31 acquires the SOCs of the batteries 22b and 22c. Subsequently, the process proceeds to step S116.

In step S116, the SOC adjuster 314 of the processing unit 31 determines whether the SOC difference between the SOCs of the batteries 22b and 22c acquired in step S115 is less than the third threshold. When it is determined that the SOC difference is less than the third threshold (YES in step S116), the process proceeds to step S117. When it is determined that the SOC difference is not less than the third threshold (NO in step S116), the process returns to step S115. This means that the SOC adjustment controlled by the SOC adjuster 314 continues, and the SOC acquirer 312 acquires the SOCs at an appropriate timing.

In step S117, the SOC adjuster 314 of the processing unit 31 controls the switcher 24 to release the series connection of the batteries 22a and 22b. At the same time, the SOC adjuster 314 controls the switcher 24 to configure a series-parallel connection state in which the batteries 22b and 22c are coupled in parallel, and the battery 22a is coupled in series with the batteries 22b and 22c to supply power to the drive motor 10. For example, referring to FIG. 2, the SOC adjuster 314 controls the switch SW-A, which corresponds to the switcher 24, to establish a connection to the contact ‘b’. The SOC adjuster 314 also controls the switch SW-B, which corresponds to the switcher 24, to establish a connection to a contact ‘b’. The SOC adjuster 314 also controls the switch SW-C, which corresponds to the switcher 24, to establish a connection to the contact ‘b’. The SOC adjuster 314 also controls the switch SW-D, which corresponds to the switcher 24, to establish a connection to a contact ‘a’. The SOC adjuster 314 also controls the switch SW-E, which corresponds to the switcher 24, to establish a connection to the contact ‘a’. The SOC adjuster 314 also controls the switch SW-F, which corresponds to the switcher 24, to establish a connection to the contact ‘b’. The SOC adjuster 314 also controls the switch SW-G, which corresponds to the switcher 24, to establish a connection to the contact ‘b’. The SOC adjuster 314 also controls the switch SW-H, which corresponds to the switcher 24, to establish a connection to the contact ‘b’. The SOC adjuster 314 also controls the switch SW-I, which corresponds to the switcher 24, to establish a connection to the contact ‘a’. The SOC adjuster 314 also controls the switch SW-J, which corresponds to the switcher 24, to establish a connection to the contact ‘a’. In step S117, the SOCs of the batteries 22a, 22b, and 22c are targeted to be balanced. Subsequently, the process proceeds to step S118.

In step S117, the target voltage acquirer 315 of the processing unit 31 may acquire the target voltage of the drive motor 10 using the method described above. The voltage controller 316 of the processing unit 31 may control the converter 50, which is an example of a voltage converter, to increase the voltage of the power supplied to the drive motor 10 to reach the target voltage acquired by the target voltage acquirer 315. This control suppresses a decrease in the system voltage that occurs because the series-parallel connection state is formed.

In step S118, the SOC acquirer 312 of the processing unit 31 acquires the SOCs of the batteries 22a, 22b, and 22c. Subsequently, the process proceeds to step S119.

In step S119, the SOC adjuster 314 of the processing unit 31 determines whether the SOC differences among the SOCs of the batteries 22a, 22b, and 22c acquired in step S118 are less than the second threshold. When it is determined that the SOC differences are less than the second threshold (YES in step S119), the process proceeds to step S120. When it is determined that the SOC differences are not less than the second threshold (NO in step S119), the process returns to step S118. This means that the SOC adjustment controlled by the SOC adjuster 314 continues, and the SOC acquirer 312 acquires the SOCs at an appropriate timing.

In step S120, the SOC adjuster 314 of the processing unit 31 controls the switcher 24 to release the series-parallel connection state and then couple the batteries 22a, 22b, and 22c in series to supply power to the drive motor 10. For example, referring to FIG. 2, the SOC adjuster 314 controls the switch SW-A, which corresponds to the switcher 24, to establish a connection to a contact ‘a’. The SOC adjuster 314 also controls the switch SW-B, which corresponds to the switcher 24, to establish a connection to the contact ‘a’. The SOC adjuster 314 also controls the switch SW-C, which corresponds to the switcher 24, to establish a connection to the contact ‘b’. The SOC adjuster 314 also controls the switch SW-D, which corresponds to the switcher 24, to establish a connection to the contact ‘b’. The SOC adjuster 314 also controls the switch SW-E, which corresponds to the switcher 24, to establish a connection to the contact ‘a’. The SOC adjuster 314 also controls the switch SW-F, which corresponds to the switcher 24, to establish a connection to the contact ‘b’. The SOC adjuster 314 also controls the switch SW-G, which corresponds to the switcher 24, to establish a connection to the contact ‘b’. The SOC adjuster 314 also controls the switch SW-H, which corresponds to the switcher 24, to establish a connection to the contact ‘b’. The SOC adjuster 314 also controls the switch SW-I, which corresponds to the switcher 24, to establish a connection to the contact ‘a’. The SOC adjuster 314 also controls the switch SW-J, which corresponds to the switcher 24, to establish a connection to the contact ‘a’. As a result, the vehicle 1 returns to normal driving from SOC adjustment driving. Subsequently, the process ends.

### 1-3. Conclusion

As described above, the processing unit 31 of the battery control apparatus 30 according to the first embodiment identifies one or more first batteries 22-1 having SOCs greater than or equal to the first threshold among three or more batteries 22. The processing unit 31 also identifies two or more second batteries 22-2 having SOCs less than the first threshold among the three or more batteries 22. The processing unit 31 controls the switcher 24 to configure a series-parallel connection state in which the identified two or more second batteries 22-2 are coupled in parallel, and the one or more first batteries 22-1 are coupled in series with the identified two or more second batteries 22-2, to supply power to the drive motor 10. The processing unit 31 controls the switcher 24 to release the series-parallel connection state when the SOC differences among the three or more batteries 22 are less than the second threshold.

In particular, in the first embodiment, to configure the series-parallel connection state, the processing unit 31 selects a particular battery 22 among the two or more second batteries 22-2 to be coupled to the identified one or more first batteries 22-1, based on the SOCs of the identified two or more second batteries 22-2. The processing unit 31 controls the switcher 24 to couple the identified one or more first batteries 22-1 and the selected batteries 22 in series to supply power to the drive motor 10. The processing unit 31 controls the switcher 24 such that, when the SOC differences among the two or more second batteries 22-2 become less than the third threshold, the series connection is released and the series-parallel connection state is configured to supply power to the drive motor 10.

In the first embodiment, the SOCs of all the batteries 22 can be balanced by using relatively rapid power consumption by the drive system, without stopping the vehicle 1 after the replacement of the batteries 22. To balance the SOCs of all the batteries 22, this configuration also avoids supplying current from the batteries 22 having higher SOC to the batteries 22 having lower SOCs for a long period of time after the batteries 22 have been switched from a series connection to a parallel connection, as in known methods. This configuration thus shortens the time to balance the SOCs of all the batteries 22 and also suppresses the circulating current flowing among the batteries 22.

### 2. Second Embodiment

A second embodiment of the disclosure will be described. The following description refers mainly to features that differ from the features of the first embodiment.

### 2-1. Configuration Example

Referring to FIG. 1, the vehicle 1 further includes an in-vehicle auxiliary device 70 that is configured to be driven by power from the batteries 22. The in-vehicle auxiliary device 70 is any electrical device that is installed in the vehicle 1 and operates at a relatively low voltage. The in-vehicle auxiliary device 70 is electrically coupled to the batteries 22 via any known or other suitable DC-DC converter 80, as well as to a low voltage battery 90. Examples of the low voltage battery 90 include a lead-acid battery and a lithium-ion battery having a rated voltage of, for example, 12 V or 24 V. However, the low voltage battery 90 is not particularly limited.

The switcher 24 further controls the connection between at least one battery 22 of the three or more batteries 22 and the in-vehicle auxiliary device 70, which is driven by power from the at least one battery 22. The same switches as the switches in the first embodiment may be used as the switcher 24.

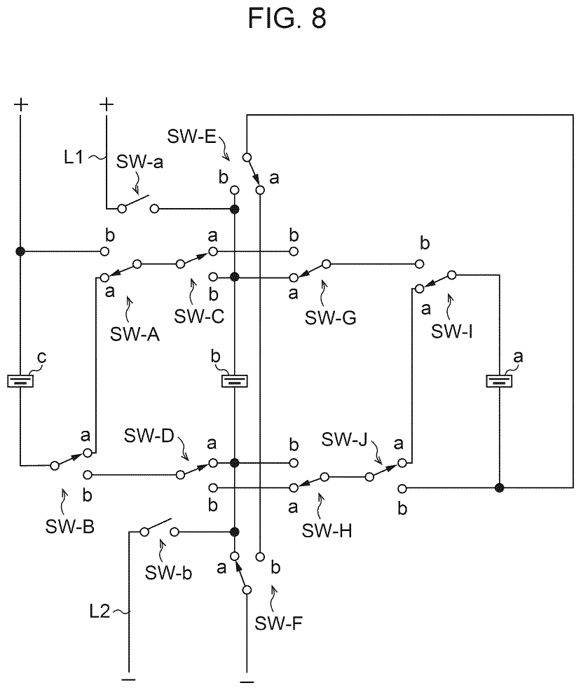

Referring to FIG. 8, an example of the configuration of the batteries 22 and the switcher 24 will be described. The circuit in the second embodiment is obtained by adding a power line L1 that is coupled to the positive terminal of the in-vehicle auxiliary device 70 via a switch SW-a, which is an example of the switcher 24, to the circuit in the first embodiment. The circuit in the second embodiment is obtained by adding a power line L2 that is coupled to the negative terminal of the in-vehicle auxiliary device 70 via a switch SW-b, which is an example of the switcher 24, to the circuit in the first embodiment. The switches SW-a and SW-b are, for example, single-pole single-throw switching elements. However, the disclosure is not limited to this example. The power lines L1 and L2 between the battery b and the in-vehicle auxiliary device 70 are illustrated in FIG. 8 as the power lines for transfer and reception of power between the batteries 22 and the in-vehicle auxiliary device 70. However, as will be readily understood by those skilled in the art, the actual implementation includes power lines (not illustrated) that enable transfer and reception of power between the battery a and the in-vehicle auxiliary device 70, and power lines (not illustrated) that enable transfer and reception of power between the battery c and the in-vehicle auxiliary device 70.

Referring to FIG. 3, the connection determiner 313 and the SOC adjuster 314 of the processing unit 31 perform the following operation to configure a series-parallel connection state described in the first embodiment. The connection determiner 313 identifies a particular battery 22 among two or more second batteries 22-2, which are identified in the same manner as in the first embodiment, to supply power to the in-vehicle auxiliary device 70, based on the SOCs of the two or more second batteries 22-2, and outputs the identification result to the SOC adjuster 314. In response to receiving the identification result from the connection determiner 313, the SOC adjuster 314 controls the switcher 24 to supply power from the identified battery 22 to the in-vehicle auxiliary device 70. The SOC adjuster 314 controls the switcher 24 such that, when the SOC differences among the two or more second batteries 22-2 become less than the third threshold, power supply to the in-vehicle auxiliary device 70 is stopped, and, similar to the first embodiment, the series-parallel connection state is configured to supply power to the drive motor 10.

Here, as an example, it is assumed that the SOC of the battery 22a is 100%, the SOC of the battery 22b is 80%, the SOC of the battery 22c is 70%, and the connection determiner 313 identifies the battery 22a as the first battery 22-1, and the batteries 22b and 22c as the second batteries 22-2. In this case, the connection determiner 313 identifies, for example, a particular battery 22b having a higher SOC of the batteries 22b of 22c as the battery to supply power to the in-vehicle auxiliary device 70. After power from the battery 22b has been consumed by the in-vehicle auxiliary device 70 until the SOC of the battery 22b reaches 70%, the SOC adjuster 314 controls the switcher 24 such that the batteries 22b and 22c are coupled in parallel, and the battery 22a is coupled in series with the batteries 22b and 22c.

### 2-2. Example of Operation of Battery Control Apparatus

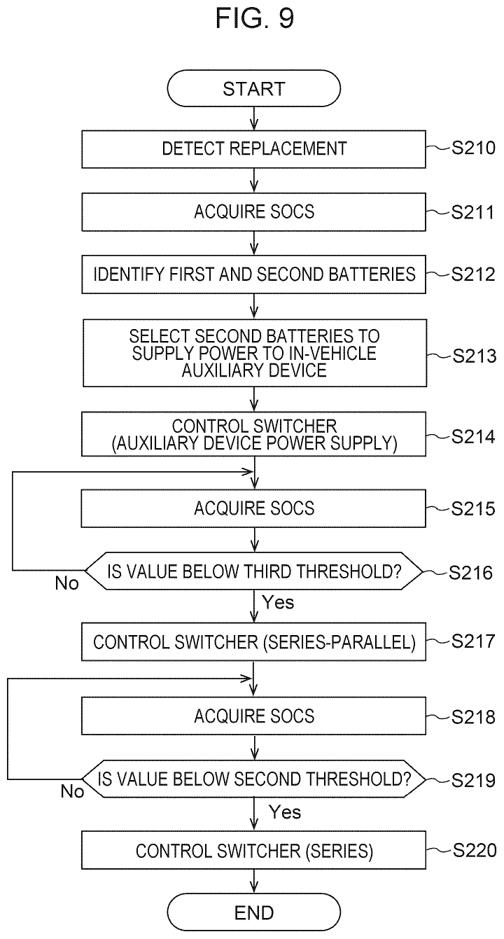

Referring to FIG. 9, an example of operation of the battery control apparatus 30 according to the second embodiment will be described following a flowchart.

For the sake of simplicity, the following description refers to a case in which the battery 22a among the replaceable batteries 22a, 22b, and 22c has been replaced. It is assumed that the SOC of the battery 22a is 100%, the SOC of the battery 22b is 80%, and the SOC of the battery 22c is 70%. It is also assumed that the batteries 22a, 22b, and 22c are used in a series connection during normal driving of the vehicle 1. However, the disclosure is not limited to these conditions.

In step S210, the replacement detector 311 of the processing unit 31 detects that the replacement of the batteries 22a, 22b, and 22c has been performed. Subsequently, the process proceeds to step S211.

In step S211, the SOC acquirer 312 of the processing unit 31 acquires the SOCs of the batteries 22a, 22b, and 22c. The SOC acquirer 312 may monitor the SOCs continuously at predetermined computation intervals during the process. The same applies to the following descriptions. Subsequently, the process proceeds to step S212.

In step S212, the connection determiner 313 of the processing unit 31 identifies, as the first battery 22-1, the battery 22a that has a SOC greater than or equal to the first threshold among the batteries 22a, 22b, and 22c. The connection determiner 313 also identifies, as the second batteries 22-2, the batteries 22b and 22c that have SOCs less than the first threshold among the batteries 22a, 22b and 22c. Subsequently, the process proceeds to step S213.

In step S213, the connection determiner 313 of the processing unit 31 selects, based on the SOCs of the batteries 22b and 22c identified in step S212, a second battery 22-2 to supply power to the in-vehicle auxiliary device 70 from the batteries 22b and 22c. In this example of operation, it is assumed that the battery 22b is selected through the method described above. Subsequently, the process proceeds to step S214.

In step S214, the SOC adjuster 314 of the processing unit 31 controls the switcher 24 to supply power from the battery 22b selected in step S213 to the in-vehicle auxiliary device 70. For example, referring to FIG. 8, the SOC adjuster 314 controls the switches SW-a and SW-b, which correspond to the switcher 24, to enter the on-state. The term “on-state” means an electrically energized state that enables transfer and reception of power between the battery b and the in-vehicle auxiliary device 70. The SOC adjuster 314 also controls the switch SW-A, which corresponds to the switcher 24, to establish a connection to the contact ‘a’. The SOC adjuster 314 also controls the switch SW-B, which corresponds to the switcher 24, to establish a connection to the contact ‘a’. The SOC adjuster 314 also controls the switch SW-C, which corresponds to the switcher 24, to establish a connection to the contact ‘a’. The SOC adjuster 314 also controls the switch SW-D, which corresponds to the switcher 24, to establish a connection to the contact ‘b’. The SOC adjuster 314 also controls the switch SW-E, which corresponds to the switcher 24, to establish a connection to the contact ‘a’. The SOC adjuster 314 also controls the switch SW-F, which corresponds to the switcher 24, to establish a connection to the contact ‘b’. The SOC adjuster 314 also controls the switch SW-G, which corresponds to the switcher 24, to establish a connection to the contact ‘b’. The SOC adjuster 314 also controls the switch SW-H, which corresponds to the switcher 24, to establish a connection to the contact ‘a’. The SOC adjuster 314 also controls the switch SW-I, which corresponds to the switcher 24, to establish a connection to the contact ‘b’. The SOC adjuster 314 also controls the switch SW-J, which corresponds to the switcher 24, to establish a connection to the contact ‘a’. The second embodiment differs from the first embodiment in that, at this time, the vehicle 1 is stationary, and no power is supplied to the drive motor 10. It is preferable to couple the batteries 22a and 22c, which are not coupled to the in-vehicle auxiliary device 70, in series from the viewpoint of suppressing circulating current. In step S214, for example, the SOC of the battery 22b is targeted to be 70%. Subsequently, the process proceeds to step S215.

In step S215, the SOC acquirer 312 of the processing unit 31 acquires the SOC of the battery 22b. Subsequently, the process proceeds to step S216.

In step S216, the SOC adjuster 314 of the processing unit 31 determines whether the SOC difference between the SOC of the battery 22b acquired in step S215 and the SOC of the battery 22c acquired in step S211 is less than the third threshold. When it is determined that the SOC difference is less than the third threshold (YES in step S216), the process proceeds to step S217. When it is determined that the SOC difference is not less than the third threshold (NO in step S216), the process returns to step S215. This means that power supply to the in-vehicle auxiliary device 70 continues, and the SOC acquirer 312 acquires the SOCs at an appropriate timing.

In step S217, the SOC adjuster 314 of the processing unit 31 controls the switcher 24 to stop power supply to the in-vehicle auxiliary device 70. For example, the SOC adjuster 314 controls the switches SW-a and SW-b, which correspond to the switcher 24, to enter the off-state. At the same time, the SOC adjuster 314 controls the switcher 24 to configure a series-parallel connection state in which the batteries 22b and 22c are coupled in parallel, and the battery 22a is coupled in series with the batteries 22b and 22c to supply power to the drive motor 10. For example, referring to FIG. 8, the SOC adjuster 314 controls the switch SW-A, which corresponds to the switcher 24, to establish a connection to the contact ‘b’. The SOC adjuster 314 also controls the switch SW-B, which corresponds to the switcher 24, to establish a connection to the contact ‘b’. The SOC adjuster 314 also controls the switch SW-C, which corresponds to the switcher 24, to establish a connection to the contact ‘b’. The SOC adjuster 314 also controls the switch SW-D, which corresponds to the switcher 24, to establish a connection to the contact ‘a’. The SOC adjuster 314 also controls the switch SW-E, which corresponds to the switcher 24, to establish a connection to the contact ‘a’. The SOC adjuster 314 also controls the switch SW-F, which corresponds to the switcher 24, to establish a connection to the contact ‘b’. The SOC adjuster 314 also controls the switch SW-G, which corresponds to the switcher 24, to establish a connection to the contact ‘b’. The SOC adjuster 314 also controls the switch SW-H, which corresponds to the switcher 24, to establish a connection to the contact ‘b’. The SOC adjuster 314 also controls the switch SW-I, which corresponds to the switcher 24, to establish a connection to the contact ‘a’. The SOC adjuster 314 also controls the switch SW-J, which corresponds to the switcher 24, to establish a connection to the contact ‘a’. In step S217, the SOCs of the batteries 22a, 22b, and 22c are targeted to be balanced. Subsequently, the process proceeds to step S218.

In step S217, the target voltage acquirer 315 of the processing unit 31 may acquire the target voltage of the drive motor 10 using the method described above. The voltage controller 316 of the processing unit 31 may control the converter 50, which is an example of a voltage converter, to increase the voltage of the power supplied to the drive motor 10 to reach the target voltage acquired by the target voltage acquirer 315. This control suppresses a decrease in the system voltage that occurs because the series-parallel connection state is formed.

In step S218, the SOC acquirer 312 of the processing unit 31 acquires the SOCs of the batteries 22a, 22b, and 22c. Subsequently, the process proceeds to step S219.

In step S219, the SOC adjuster 314 of the processing unit 31 determines whether each of the SOC differences among the SOCs of the batteries 22a, 22b, and 22c acquired in step S218 is less than the second threshold. When it is determined that each SOC difference is less than the second threshold (YES in step S219), the process proceeds to step S220. When it is determined that any of the SOC differences is not less than the second threshold (NO in step S219), the process returns to step S218. This means that the SOC adjustment controlled by the SOC adjuster 314 continues, and the SOC acquirer 312 acquires the SOCs at an appropriate timing.

In step S220, the SOC adjuster 314 of the processing unit 31 controls the switcher 24 to release the series-parallel connection state and then couple the batteries 22a, 22b, and 22c in series to supply power to the drive motor 10. For example, referring to FIG. 8, the SOC adjuster 314 controls the switch SW-A, which corresponds to the switcher 24, to establish a connection to the contact ‘a’. The SOC adjuster 314 also controls the switch SW-B, which corresponds to the switcher 24, to establish a connection to the contact ‘a’. The SOC adjuster 314 also controls the switch SW-C, which corresponds to the switcher 24, to establish a connection to the contact ‘b’. The SOC adjuster 314 also controls the switch SW-D, which corresponds to the switcher 24, to establish a connection to the contact ‘b’. The SOC adjuster 314 also controls the switch SW-E, which corresponds to the switcher 24, to establish a connection to the contact ‘a’. The SOC adjuster 314 also controls the switch SW-F, which corresponds to the switcher 24, to establish a connection to the contact ‘b’. The SOC adjuster 314 also controls the switch SW-G, which corresponds to the switcher 24, to establish a connection to the contact ‘b’. The SOC adjuster 314 also controls the switch SW-H, which corresponds to the switcher 24, to establish a connection to the contact ‘b’. The SOC adjuster 314 also controls the switch SW-I, which corresponds to the switcher 24, to establish a connection to the contact ‘a’. The SOC adjuster 314 also controls the switch SW-J, which corresponds to the switcher 24, to establish a connection to the contact ‘a’. The switches SW-a and SW-b remain in the off-state. As a result, the vehicle 1 returns to normal driving. Subsequently, the process ends.

### 2-3. Conclusion

As described above, the processing unit 31 of the battery control apparatus 30 according to the second embodiment identifies one or more first batteries 22-1 having SOCs greater than or equal to the first threshold among three or more batteries 22. The processing unit 31 also identifies two or more second batteries 22-2 having SOCs less than the first threshold among the three or more batteries 22. The processing unit 31 controls the switcher 24 to configure a series-parallel connection state in which the identified two or more second batteries 22-2 are coupled in parallel, and the one or more first batteries 22-1 are coupled in series with the identified two or more second batteries 22-2, to supply power to the drive motor 10. The processing unit 31 controls the switcher 24 to release the series-parallel connection state when the SOC differences among the three or more batteries 22 are less than the second threshold.

In particular, in the second embodiment, the switcher 24 further controls the connection between at least one battery 22 of the three or more batteries 22 and the in-vehicle auxiliary device 70, which is driven by power from the at least one battery 22. To configure the series-parallel connection state, the processing unit 31 identifies a particular battery 22 among the two or more second batteries 22-2 to supply power to the in-vehicle auxiliary device 70, based on the SOCs of the identified two or more second batteries 22-2. The processing unit 31 controls the switcher 24 to supply power from the identified battery 22 to the in-vehicle auxiliary device 70. The processing unit 31 controls the switcher 24 such that, when the SOC differences among the two or more second batteries 22-2 become less than the third threshold, power supply to the in-vehicle auxiliary device 70 is stopped and the series-parallel connection state is configured to supply power to the drive motor 10.

In the second embodiment, although the vehicle 1 is to be stationary while power is being consumed by the in-vehicle auxiliary device 70, because auxiliary device systems consume less power than drive systems, degradation of the batteries 22 caused by SOC adjustment can be suppressed. To balance the SOCs of all the batteries 22, this configuration also avoids supplying current from the batteries 22 having higher SOC to the batteries 22 having lower SOCs for a long period of time after the batteries 22 have been switched from a series connection to a parallel connection, as in known methods. This configuration thus shortens the time to balance the SOCs of all the batteries 22 and also suppresses the circulating current flowing among the batteries 22.

The preceding discussion has described preferred embodiments of the disclosure in detail with reference to the accompanying drawings, but the disclosure is not limited to these examples. It is understood that various modifications and alterations within the scope of the technical idea indicated in the appended claims may occur to those skilled in the art and are also embraced within the technical scope of the disclosure. For example, functional elements and the like included in the configuration elements, operational steps, or other elements may be repositioned; multiple configuration elements, operational steps, or other elements may be combined into single elements or further divided.

### 3. First Modification

As a first modification, the SOC adjuster 314 of the processing unit 31 may control the switcher 24 to couple in parallel at least one first battery 22-1 of the one or more first batteries 22-1 and at least one second battery 22-2 of the two or more second batteries 22-2 to configure the series-parallel connection state described above. The SOC adjuster 314 may control the switcher 24 such that, when the SOC differences among the two or more second batteries 22-2 become less than the third threshold, the parallel connection is released and the series-parallel connection state is configured to supply power to the drive motor 10.

Here, as an example, it is assumed that the SOC of the battery 22a is 100%, the SOC of the battery 22b is 80%, the SOC of the battery 22c is 70%, and the battery 22a is identified as the first battery 22-1 and the batteries 22b and 22c are identified as the second batteries 22-2. In this case, the SOC adjuster 314 controls the switcher 24 to couple the battery 22a and the battery 22c having the lower SOC of the batteries 22b and 22c in parallel. Subsequently, the SOC adjuster 314 causes power from the battery 22a to flow to the battery 22c until the SOC of the battery 22c reaches 80%. At this time, the vehicle 1 is stationary, and no power is supplied to the drive motor 10. Subsequently, the SOC adjuster 314 controls the switcher 24 such that the batteries 22b and 22c are coupled in parallel, and the battery 22a is coupled in series with the batteries 22b and 22c. At this time, power is supplied to the drive motor 10, and the vehicle 1 performs SOC adjustment driving.

In the first modification, although the vehicle 1 is to be stationary while the parallel connection is maintained, because power consumption is slower than power consumption in the first embodiment, degradation of the batteries 22 caused by SOC adjustment can be suppressed. This configuration also avoids supplying current from the batteries 22 having higher SOC to the batteries 22 having lower SOCs for, for example, about one hour after the batteries 22 have been switched from a series connection to a parallel connection to balance the SOCs of all the batteries 22 as in known methods. In other words, it is unnecessary to balance the SOCs of all the batteries 22; for example, it is sufficient that current is supplied from the battery 22a to the battery 22c until the SOC of the battery 22c decreases from 80% to 70%, and after this, the SOC adjustment is performed using the drive system. As a result, the time until the SOCs of all the batteries 22 are balanced is shortened.

In the first modification, the SOC adjuster 314 may control the switcher 24 such that, for example, when the current from the battery 22a to the battery 22c approaches an equilibrium state and becomes difficult to flow during the parallel connection, power is supplied from the battery 22b to the in-vehicle auxiliary device 70, similarly to the second embodiment. As a result, for example, the SOCs of the batteries 22b and 22c become balanced, so that the series-parallel connection state described can be configured.

### 4. Second Modification

As a second modification, the first and second embodiments may be combined. As an example, it is assumed that the SOC of the battery 22a is 100%, the SOC of the battery 22b is 80%, and the SOC of the battery 22c is 70%. In this case, the batteries 22a and 22b may be coupled in series and power may be supplied to the drive motor 10, similarly to the first embodiment; in addition, power from the battery 22c may be supplied to the in-vehicle auxiliary device 70, similarly to the second embodiment; and when the SOCs of the batteries 22b and 22c become balanced, the series-parallel connection state described above may be configured.

### 5. Third Modification

As a third modification, when the processing unit 31 of the battery control apparatus 30 detects, using the method described above, that replacement of the batteries 22 has been performed, the processing unit 31 of the battery control apparatus 30 may perform processing to prompt the driver who operates the vehicle 1 to select between (i) SOC adjustment in the first embodiment or (ii) SOC adjustment in the second embodiment. For example, the processing unit 31 of the battery control apparatus 30 may output a question prompting the driver to select between (i) and (ii) described above, through text or image display, or audio output via, for example, a car navigation device (not illustrated) installed in the vehicle 1, and may select SOC adjustment of (i) or (ii) described above according to the answer from the driver. The question may include a question to ask the driver whether to perform SOC adjustment in the first or second modification, instead of or in addition to (i) or (ii) described above.

### 6. Others

The technology of the disclosure may also be realized as a vehicle 1 equipped with the battery control apparatus 30 according to any of the embodiments or modifications described above, a battery control method implemented by the battery control apparatus 30 according to any of the embodiments or modifications, a computer program that causes a computer to serve as the battery control apparatus 30 according to any of the embodiments or modifications, or a non-transitory tangible recording medium storing the computer program.

According to one embodiment of the disclosure, the time to balance the SOCs of all batteries can be shortened, and the circulating current flowing among the batteries can be suppressed.

The battery control apparatus 30 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the replacement detector 311, the SOC acquirer 312, the connection determiner 313, the SOC adjuster 314, the target voltage acquirer 315, and the voltage controller 316. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and an NVRAM. The ASIC is an integrated circuit (IC) customized to perform, and the FPGA is an integrated circuit designed to be configured after manufacturing in order to perform, all or a part of the functions of the modules illustrated in FIG. 3.

1. A battery control apparatus configured to be applied to a battery system comprising three or more batteries configured to supply power to a drive motor of a vehicle, and a switcher configured to switch connections between the three or more batteries, the battery control apparatus comprising:
one or more processors and one or more memories communicatively coupled to the one or more processors, wherein
the one or more processors are configured to
identify one or more first batteries having respective states of charge greater than or equal to a first threshold among the three or more batteries,
identify two or more second batteries having respective states of charge less than the first threshold among the three or more batteries,
control the switcher to configure a series-parallel connection state by coupling the identified two or more second batteries in a parallel connection and coupling the one or more first batteries in a series connection with the identified two or more second batteries to supply power to the drive motor, and
control the switcher to release the series-parallel connection state when state-of-charge differences among the three or more batteries are less than a second threshold.

2. The battery control apparatus according to claim 1, wherein
the one or more processors are configured to configure the series-parallel connection state by
selecting a battery to be coupled to the identified one or more first batteries from among the two or more second batteries based on the respective states of charge of the identified two or more second batteries,
controlling the switcher to couple the identified one or more first batteries and the selected battery in a series connection to supply power to the drive motor, and
controlling the switcher to, when state-of-charge differences among the two or more second batteries are less than a third threshold, release the series connection and configure the series-parallel connection state to supply power to the drive motor.

3. The battery control apparatus according to claim 1, wherein
the switcher is configured to further control a connection between one or more batteries of the three or more batteries and an in-vehicle auxiliary device configured to be driven by power from the one or more batteries of the three or more batteries, and
the one or more processors are configured to configure the series-parallel connection state by
identifying a battery to supply power to the in-vehicle auxiliary device among the two or more second batteries based on the respective states of charge of the identified two or more second batteries,
controlling the switcher to supply power from the identified battery to the in-vehicle auxiliary device, and
controlling the switcher to, when state-of-charge differences among the two or more second batteries are less than a third threshold, stop power supply to the in-vehicle auxiliary device and configure the series-parallel connection state to supply power to the drive motor.

4. The battery control apparatus according to claim 1, wherein
the one or more processors are configured to configure the series-parallel connection state by
controlling the switcher to couple one or more of the one or more first batteries and one or more of the two or more second batteries in a parallel connection, and
controlling the switcher to, when state-of-charge differences among the two or more second batteries are less than a third threshold, release the parallel connection and configure the series-parallel connection state to supply power to the drive motor.

5. The battery control apparatus according to claim 1, wherein
the battery system further comprises a voltage converter configured to increase or decrease a voltage of power from the three or more batteries, and
the one or more processors are configured to, while the series-parallel connection state is maintained
acquire a target voltage of the drive motor, and
control the voltage converter to increase or decrease the voltage of power to the drive motor to the target voltage.

6. The battery control apparatus according to claim 2, wherein
the battery system further comprises a voltage converter configured to increase or decrease a voltage of power from the three or more batteries, and
the one or more processors are configured to, while the series-parallel connection state is maintained
acquire a target voltage of the drive motor, and
control the voltage converter to increase or decrease the voltage of power to the drive motor to the target voltage.

7. The battery control apparatus according to claim 3, wherein
the battery system further comprises a voltage converter configured to increase or decrease a voltage of power from the three or more batteries, and
the one or more processors are configured to, while the series-parallel connection state is maintained
acquire a target voltage of the drive motor, and
control the voltage converter to increase or decrease the voltage of power to the drive motor to the target voltage.

8. The battery control apparatus according to claim 4, wherein
the battery system further comprises a voltage converter configured to increase or decrease a voltage of power from the three or more batteries, and
the one or more processors are configured to, while the series-parallel connection state is maintained
acquire a target voltage of the drive motor, and
control the voltage converter to increase or decrease the voltage of power to the drive motor to the target voltage.
